(19) United States
(12) Patent Application Publication
(10) Pub. No.: US 2014/0265564 A1
(43) Pub. Date: Sep. 18, 2014

(54) SOLAR DEVICE WITH REMOVABLE CASSETTE

(71) Applicant: THIRD WAVE POWER PTE LTD, Singapore (SG)

(72) Inventors: Chuin Kiat LIM, Singapore (SG); Wai Jye CHAN, Singapore (SG); Van Fook LIEW, Singapore (SG)

(73) Assignee: THIRD WAVE POWER PTE LTD, Singapore (SG)

(21) Appl. No.: 13/834,127

(22) Filed: Mar. 15, 2013

(51) Int. Cl. H02J 7/35; H02J 7/02

(52) U.S. Cl. CPC H02J 7/35; H02J 7/025
USPC 307/18; 136/251; 320/101

(57) ABSTRACT

Some embodiments described herein generally relate to a solar device with a removable cassette. The removable cassette is configured to dock with the solar device such that, in an engaged position, it may receive electrical energy generated from solar energy by a solar panel of the device, from internal batteries charged by the solar panel or an external power source. The cassette may include at least one of a battery and a power-consuming accessory, such as a wireless router, data storage, an output adapter, or the like. The internal batteries are configured to charge the cassette in cases where the solar panel is not generating electrical energy because of dim lighting or lack of lighting.

### BACKGROUND

Many electrical devices commonly utilize batteries as a power source. However, any given battery can only supply power to a device for a limited period of time. Such electrical devices, including mobile phones, tablets, wireless messaging devices and media players, are used more and more frequently and for extended periods of time. Consequently, it may be necessary to recharge the battery very frequently. However, it is inconvenient for users to constantly carry with them spare batteries or a charger.

Solar panels, which generate power using light from the sun, have been proposed as a potential source of energy for recharging electronic devices. However, the size of the solar panels may be too cumbersome to be used as a portable energy source. To provide adequate solar capability, the solar panel must increase in size, compromising portability. Further disadvantages of the solar panels include slow charge times and the inability to efficiently deliver power in less than full sunlight.

### SUMMARY

The technologies described herein generally relate to a device including a solar panel and a removable cassette that may be charged or powered using electrical energy generated from solar energy by the solar panel.

In some embodiments, the technologies described herein include a solar device which may include a housing including a first portion secured to a second portion, the first portion having a light-transmitting region, a solar panel disposed beneath the light-transmitting region of the first portion of the housing, an opening in a region of the second portion of the housing, the opening having first electrical contacts coupled to the solar panel, a removable battery configured to be moved between an engaged position, wherein the removable battery is disposed in and releasably engaged with the opening, and a disengaged position, wherein the battery is released from the opening, the battery having second electrical contacts positioned to couple to the first electrical contacts when the removable battery is in the engaged position and at least one internal battery coupled to the solar panel and the first electrical contacts.

In other embodiments, the technologies described herein include a solar device including a housing including an opening on an external surface thereof, at least one electrical contact positioned within the opening, a solar panel disposed in the housing and coupled to the at least one electrical contact and a cassette including at least one power-consuming device, the cassette having a shape substantially corresponding to a shape of the opening and including at least another electrical contact positioned to contact the at least one contact when the cassette is disposed in the opening to enable transfer of electrical energy generated by the solar panel to the cassette.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

In the drawings:

FIG. 1 is an illustration of a perspective view of an embodiment of a solar device that may include a removable cassette;

FIG. 2A is an illustration of a back view of the embodiment of the solar device showing the removable cassette in an engaged position;

FIG. 2B is an illustration of an embodiment of a user interface;

FIGS. 3 and 4 are illustrations of a first side view and a second side view, respectively, of the embodiment of the solar device;

FIG. 5 is an illustration of a top view of the embodiment of the solar device;

FIG. 6 is an illustration of a bottom view of the embodiment of the solar device;

FIG. 7 is an illustration of a perspective view of the embodiment of a solar device with the removable cassette in the disengaged position; and

FIGS. 8-12 are flow charts illustrating an embodiment of a method of charging a battery, such as that in the removable cassette.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

Some embodiments described herein generally relate to a solar device with a removable cassette. The cassette is configured to dock with the solar device such that, in an engaged position, the cassette may receive electrical energy generated from solar energy by a solar panel of the device or via the internal batteries. As a non-limiting example, the cassette may include at least one of a battery and a power-consuming accessory. The power-consuming accessory may include, but is not limited to, networking devices (e.g., 3G/Wifi routers), power devices (e.g., battery cassettes), lighting devices (e.g., room light), storage devices (e.g., hard disk cassette, flash drive cassette, etc.), data collection devices (e.g., PH meter, oscilloscope, etc.), environmental devices (e.g., water purification, air condensation, etc.) and navigation devices (e.g., GPS). As another non-limiting example, the power-consuming accessory may be a medical device, such as a blood pressure or heart rate monitor, or the like.

The cassette may be disengaged from the device and may function independently of the device using power stored in the cassette by the device. In embodiments in which the cassette is a battery, for example, the battery may be removed from the device and may be used as an external power source to charge other devices, such as smartphones, tablet computers, laptop computers, etc. The device may include internal batteries that store power generated by the solar panel when the cassette is in the disengaged position. Such internal batteries are configured to charge the cassette when it is docked with the device, even if the solar panel is not generating electrical energy because of dim lighting or lack of lighting. Thus, the device provides the unique capability of providing power in the absence of sufficient light for the solar panel to generate electrical energy.

As will be discussed, the technologies described herein provide a fast-charging, portable, versatile, and robust charging system.

FIG. 1 is an illustration of a perspective view of an embodiment of a solar device that may include a removable cassette. The solar device 100 may be configured to collect solar energy and convert such solar energy into electricity, and additionally to store the electricity internally. As will be discussed, the electricity generated by the solar device may be used to power the removable cassette 101 including a removable battery or one or more power-consuming accessories, such as a wireless router, data storage, an output adapter, an external solar panel, and the like.

The solar device 100 may include a solar panel 102 disposed in a housing 104 including a first portion 106 and a second portion 108. The first and second portions 106 and 108 of the housing 104 may be formed from a substantially rigid or semirigid material, such as a plastic or polymer material. The first portion 106 may include a top flange 110 and a bottom flange 112 extending substantially perpendicularly from a first surface 114 of the first portion 106. The first portion 106 may additionally include a frame 118 and a screen 120 that may be formed from a material that allows light to pass through, such as a transparent, translucent, semitransparent, or light-transmitting material. The frame 118 and the top and bottom flanges 110 and 112 and the second portion 108 may be formed from a colored material, or may be painted to be a desired color. The solar panel 102 may be disposed beneath the screen 120 such that light may be transmitted to the solar panel 102.

The second portion 108 may include a first side flange 122 and a second side flange 124 extending substantially perpendicularly from a second surface 126 of the second portion 108. While edges 128 of the first portion 106 and the second portion 108 are illustrated as being beveled or curved in FIG. 1, the edges 128 may be any shape, such as square.

The top and bottom flanges 110 and 112 of the first portion 106 generally correspond with recesses between the first and second side flanges 122 and 124 of the second portion 108 and the first and second side flanges 122 and 124 generally correspond with recesses between top and bottom flanges 110 and 112 of the first portion 106. Thus, the first portion 106 and the second portion 108 may be joined together to form the housing 104. Optionally, a seal 130 may be disposed between abutting surfaces of the first portion 106 and the second portion 108 such that the housing 104 is substantially impermeable to liquids, such as water.

As a non-limiting example, the first portion 106 and the second portion 108 may be removably secured or attached to one another by one or more fasteners, such as screws 132. As another non-limiting example, the first portion 106 and the second portion 108 may be secured to one another using a frictional connection such as a press-fit, a snap-fit, or other suitable frictional connection.

The solar device 100 may optionally include a handle 134 which may be attached to the solar device 100 by a clip 136. The clip 136 may be secured to the second portion 108 of the housing 104, for example, by a snap-fit. The handle 134 may be rotatably attached to the clip 136 such that the handle 134 may be rotated about a point of rotation, as will be described. For example, the handle 134 may be attached to the clip 136 by a screw or the like. The handle 134 may optionally include a grip 138 to aid a user in grasping and holding the solar device 100. The handle 134 may be formed from a substantially rigid material and, thus, may be used as a support or stand for the solar device 100. As a non-limiting example, the handle may be used to prop the solar device 100 up and to adjust an angle of the solar panel 102.

For example, the solar panel 102 may include a base formed from a polycrystalline material, such as polycrystalline silicon. One or more solar cells, or an array of solar cells, may be disposed on the polycrystalline base. For example, the polycrystalline material may have a thickness of between about 0.25 mm and about 1.5 mm and, more particularly, between about 0.5 mm and about 1 mm, and more particularly still, about 0.85 mm. As a non-limiting example, the solar cells may have an efficiency of between about 16% and about 17% and, more particularly, about 17.5%. The solar panel 102 may additionally include a dense array of the solar cells including an increased number of solar cells per area unit than conventional solar cells. For example, the solar panel 102 may be a 5 Watt (W) solar panel that is capable of providing up to 1 ampere (amp) of current to fast charge the removable battery. The solar panel may be encapsulated with a polymer material, such as an epoxy or other resin.

The solar device 100 includes a charging circuit designed to charge in constant current mode for almost the entire charge duration. With lA current from the solar panel, the batteries are filled rapidly.

The charging circuit also includes a booster circuit that steps up output voltage of the solar panel 102 so that the solar panel 102 continues to provide a charging current even when the solar panel 102 is exposed to less than full light or sun, minimizing the total amount of charge time.

The charging circuit includes a maximum power point tracking (MPPT) design that enables the solar panel to operate at its maximum power point regardless of the level of light to which it is exposed. This allows an optimum amount of power to be extracted from the solar panel 102 at all times. The combination of the high-efficiency solar panel, the booster circuit, and the MPPT enables the solar device 100 to provide increased charging speeds, and at the same time providing a superior charging experience in less than full sunlight.

Additionally, the solar device 100 may include internal batteries (not shown) coupled to the solar panel 102 such that electrical energy generated by the solar panel 102 when the solar panel is exposed to solar energy (i.e., light) is stored in the internal batteries. As will be discussed, the internal batteries of the solar device 100 may be coupled to the cassette 101 such that power stored in the internal batteries may be transmitted to the cassette 101 during periods when the solar panel 102 is not exposed to light, or is not generating power for any other reason.

FIG. 2A is an illustration of a back view of the embodiment of the solar device 100 showing the removable cassette in an engaged position. A cassette 140 may be engaged with the second portion 108 of the solar device 100. By way of example and not limitation, the cassette 140 may include the removable battery or other accessory, such as a wireless router, data storage, an output adapter, or the like. The cassette 140 may include a power/control button 144 on an outer surface thereof. The cassette 140 may fit within an opening 142 within the second portion 108. For example, the cassette 140 may have one or more features than enable it to dock with the solar device 100, such as electrical connectors and/or a locking mechanism.

The second portion 108 of the housing 104 may include feature covers 146 and 148 in the first and second side flanges 122 and 124, respectively. The feature covers 146 and 148 may be formed, for example, from a deformable, resilient, or flexible material, such as a rubber or polymeric material. The second portion 108 may further include a panel 150 having a light source 152 and/or a user interface 154 thereon. While the light source 152 is shown in FIG. 2 including a single light, the light source 152 may include any number of lights, or an array of lights and may have any configuration. In addition, the light source 152 may have any desired shape, and may be located in any position on the solar device 100. For example, the light source 152 may include one or more light-emitting diodes (LEDs) that may function as a powerful reading or utility light.

FIG. 2B is an enlarged view of an embodiment of the user interface 154 shown in FIG. 2A. The user interface 154 may include a plurality of LEDs that may be configured to function as indicator lights, which indicate one or more of a function of the device 100, a level of charge of the battery of the cassette 140 or a level of power being generated by the solar panel 102, or stored in the solar device 100, at a given time.

As a non-limiting example, the user interface 154 may be designed as an overlay that sticks over circular led lights above the cassette 101. Examples of controls/icons that may be included on the user interface include, but are not limited to, controls for FM and AM radio 302, volume 304, SOS lights 306, flashlight 308, remaining battery capacity 310, reading light 312, insect repellent 314, radio channel seek station 316 and radio channel store station 318.

FIGS. 3 and 4 are illustrations of a first side view and a second side view, respectively, of the embodiment of the solar device 100 in which the feature covers 146 and 148 (shown in FIG. 2) have been removed to show examples of underlying features. The first side flange 122 and the second side flange 124 of the second portion 108 may respectively include a first opening 156 and a second opening 170 in which one or more features are disposed. Such features may include ports, buttons, connectors, controls, etc. As a non-limiting example, the first opening 156 may include USB ports 158, connectors 160 and 162 for securing the feature cover 146, and a mini USB port 164 and the second opening 170 may include a headphone or microphone port 172, a speaker 174, and a thumbwheel 176 which may be used as a volume control and feature selection control.

In addition to the LED reading light, the solar device 100 may include a flashlight, an AM/FM radio, an insect repellent, and an SOS Morse code signal, all of which may be powered by the electrical energy generated by the solar panel 102. These features may be activated through the circular user interface 154 wherein rotating the thumbwheel 174 causes a corresponding LED on the user interface 154 to light up. Depressing the thumbwheel 174 then activates the selected feature, for example, the radio, reading light, flashlight or insect repellant.

The ports enable multiple devices to be charged (such as devices enabled with USB connection) and enable the solar device 100 to be connected to an external source of electricity, such as a wall outlet. The solar device 100 electronics may evaluate which sources of power are available and may determine which of such sources should be used based on priority. The solar device 100 may be configured such that power is only used from the external source or internal batteries if power from the solar panel 102 is not available or does not meet demands. As a non-limiting example, the solar device 100 may use power generated by the solar panel 102 as the primary source, the external source as a secondary source, and the internal batteries as a tertiary source.

Each side of the solar device 100 may include attachment points 165 configured to receive and removably attach mounts or holders, such as a stand or lanyard, to the solar device 100. Grommets 166 and 168, or other sealing mechanisms, may be positioned within the respective openings 156 and 170 to prevent liquid and debris from entering the solar device 100.

FIG. 5 is an illustration of a top view of the embodiment of the solar device 100. The top flange 110 of the first portion 106 may include one or more openings for features which may include, but are not limited to, a lanyard connector 178, ports 180 and 182, and a USB port 184. For example, a surface of the cassette 101 may be exposed through a notch 107 that extends through the top flange 110 of the first portion 106. The notch 107 may have a shape that generally corresponds to a shape of the surface of the cassette 101 that is exposed through the notch 107. In addition, an opening for a lever 188 of a locking mechanism 186 configured to releasably engage the cassette 101 may be included in the top flange 110. As will be discussed in further detail, the locking mechanism 186 enables the cassette 101 to be easily docked with the solar device 100 with a simple click wherein protruding member 187 of, for example, a spring-loaded plunger, engages with the cassette 101 and further enables the cassette 101 to be easily removed using one thumb by unlocking the protruding member 187 using the lever 188.

FIG. 6 is an illustration of a bottom view of the embodiment of the device 101. The bottom flange 112 of the first portion 106 may include one or more openings for features which may include, but are not limited to, a power button 192 and a light 194. The bottom flange 112 may include attachment points 185 configured to receive and removably attach mounts or holders, such as a stand or lanyard, to the solar device 100.

Referring to FIGS. 5 and 6, grommets 190, or other sealing mechanisms, may be positioned within the respective openings to prevent liquid and debris from entering the solar device 100. The handle 134 may be secured to the solar device 100 by the clip 136 and/or a fastener 189. The handle 134 may be moved about the axis of rotation 191 to enable the handle 134 to function as a handle, a hook for hanging on other objects (e.g., walls) or stand, which can hold the device in a vertical position such that the light source 152 (FIG. 2) may be used as a reading light.

FIG. 7 is an illustration of a perspective view of the embodiment of a solar device with the removable cassette in the disengaged position. The cassette 101 has a size and weight suitable for portability, such as in a conventional shirt or pants pocket. For example, the cassette 101 may have a thickness of between about 5 mm and about 30 mm and, more particularly, between about 10 mm and about 20 mm and, more particularly, about 14 mm. The cassette 101 may have a weight of between about 50 g and about 200 g and, more particularly, about 150 g. In embodiments in which the cassette 101 is a battery, the battery may be a lithium polymer battery capable of withstanding temperatures exceeding 80° C. and may provide up to 5000 mAh of battery capacity or more.

The cassette 101 may have a shape that substantially corresponds to a shape of the opening 142 such that one or more exposed surfaces of the cassette 101 are substantially planar with one or more exposed surfaces of the housing 104. The opening 142 may be defined by a lower surface and three sidewalls in the second surface 126 of the second portion 108 of the housing 104 and a notch 201 in the top flange 110 of the first portion 106 such that a surface of the cassette 101 is exposed through the top flange 110 when the cassette 101 is in the engaged position. As a non-limiting example, the cassette 101 may have a thickness that is substantially the same as the height of sidewalls 202 within the opening 142 such that the exposed surface 200 of the cassette 101 is substantially planar with the second surface 126 of the second portion 108.

As a non-limiting example, the cassette 101 may have a thickness that is substantially greater than or less than the height of sidewalls 202 within the opening 142 to accommodate devices of differing size. For example, such devices may include, but are not limited to, battery cassettes with larger capacities, cassette with a large room light or other devices requiring more space. While the surface 200 of the cassette 101 is shown as being flush with the second surface 126, the surface 200 of the cassette 101 may additionally protrude above or may be recessed below the second surface 126.

The cassette 101 may further include a protrusion 204 sized and configured to engage with a recess 206 and a lip 208 in one of the sidewalls 202 in the opening 142. The cassette 101 may also include projections 210 on at least one surface. The projections 210 may generally correspond to depressions in at least one of the sidewalls 202 of the opening 142 such that the projections 210 engage the depressions to guide the cassette 101 into the opening 142.

One or more electrical contacts 196 may be disposed in the opening 142. The electrical contacts 196 may be coupled to the solar panel 102 such that electrical energy generated by the solar panel 102 may be transmitted through the electrical contacts 196. The electrical contacts 196 may also be coupled to the internal batteries such that electrical energy stored in the internal batteries may be transmitted through the electrical contacts 196. The cassette 101 may include electrical contacts that correspond to the electrical contacts in the opening 142 such that electrical energy may be transmitted to the cassette 101. The electrical contacts may include a six (6) pin interface that enables identification of the cassette 101. After identification, functions of the cassette 101 may be controlled (e.g., charging, sending data, communication, etc.).

The 6 pin contact enables power and smart data to be exchanged between the solar device 100 and the cassette 101. For example, data related to remaining battery capacities of internal or external battery, sun intensity, health of the batteries, temperature of the device and other characteristics and device capabilities may be exchanged. This enables the solar device 100 and/or cassette 101 to adjust itself to accommodate real-time changes. As a non-limiting example, as the battery cassette 101 approaches full charge or low charge, the solar device can adjust charging algorithms to optimize charging by detecting the charge of the battery and determining how to charge the battery based on available sources of power. As another non-limiting example, when sun intensity is low, the cassette 101 may be charged in trickle mode. As yet another non-limiting example, the cassette 101 may include a 3G/wifi router, with a suitable application on a remote device such as a smartphone, one can remotely access data or status of the solar device 100 and/or the cassette 101, enabling it to be monitored and controlled remotely.

In further detail, the electrical contacts 196 are coupled with the internal batteries to enable power generated by the solar panel 102 and stored by the internal batteries to be utilized by the cassette 101. In embodiments in which the cassette 101 is a removable battery, the internal batteries may continue to charge the batteries when the solar panel 102 is not receiving sufficient light to generate power. In embodiments in which the cassette 101 is a wireless router, the internal batteries may enable the wireless router to function when the solar panel 102 is not receiving sufficient light to generate power.

The cassette 101 may be removably secured within the opening 142 by any suitable mechanism. For example, the cassette 101 may include an aperture 198 configured to receive the protruding member 187 (FIG. 5) of the spring-loaded plunger within the opening 142 to removably secure the cassette 101 within the opening 142. The lever 188 is configured to release the cassette 101 from the opening 142 by moving the protruding member 187 of the spring-loaded plunger away from the aperture 198 when pressure is applied to the lever 188. The cassette 101 may, thus, be easily docked with and removed from the solar device 100 with a simple click.

For example, the cassette 101 may be a battery system that is expandable and can go from 2500 mAh capacity to 11600 mAh and beyond.

The solar device 100, thus, may enable direct charging or indirect charging of the cassette 101 including a battery or power-consuming device in the dark or in dim lighting using electrical energy generated from solar energy by the solar panel 102. Furthermore, the high-efficiency solar panel 102 enables the solar device 100 to provide users with maximum portability, efficient solar-charging capability, minimal wait time to recharge, and the ability to recharge or power devices even when solar energy is not available. The solar device 100 includes multiple ports, such as USB and mini USB ports that enable charging of different devices, such as a powerful LED reading light, a flashlight, an AM/FM radio, an insect repellent and an SOS Morse code signal, all built into a single device. Thus, the solar device 100 provides multifunction capabilities to users.

FIGS. 8-12 illustrate an embodiment of systems and methods for charging a battery, such as a battery in the removable cassette. The systems and methods provide a portable solar charger system where a portable battery will be charged continuously with or without light.

FIG. 8 is a block diagram illustrating an embodiment of configuration of a portable solar charger system 800 including a solar cell 802, power control circuitry 803 and an internal or primary battery 804. A portable battery 806, such as the cassette 101 (FIG. 1), may be attached to the system 800. FIG. 9 is a block diagram illustrating an embodiment of a configuration of an energy flow diagram of the portable solar system including a solar cell 902, first, second and third switches 904, 908 and 920, a battery isolator switch 912; multipliers 903, 905 and 907, a direct current (DC) supply 906, a charger 910, a primary battery 914, a 5 volt booster 916, a micro-controller 918, and a removable portable battery cassette 922. When the portable battery 922 is absent, the primary battery 914 will be charged by the solar cell 902 for later use. When the portable battery 922 is present, the portable battery 922 will be charged by the solar cell 902 in the presence of light. In the absence of light, the portable battery 922 will be continuously charged by the primary battery 914. After the portable battery 922 is completely charged, the primary battery 914 will then be charged.

FIGS. 10-12 illustrate an embodiment of a system control algorithm, which may be executed by the micro-controller 918, to control the portable solar charger system. As shown in FIG. 10, the method may begin with the inquiry of whether the cassette is present in the device. For example, the cassette may be detected using the 6 pin interface that connect the cassette and the device and enable detection of the device. If the cassette is not present, the first switch 904 (SW1) may be opened, the second switch 908 (SW2) may be closed and the third switch 920 may be opened. If the cassette is determined to be present, the inquiry of whether the external DC supply 906 is present or available. If the DC supply 906 is unavailable, the flow may proceed to FIG. 11. If the DC supply 906 is unavailable, the flow may proceed to FIG. 12.

Referring to FIG. 11, it may be determined if the battery of the cassette is fully charged. If the battery is not fully charged the first switch 904 (SW1) may be closed, the second switch 908 (SW2) may be opened and the third switch 920 may be closed. If the battery is fully charged, the first switch 904 (SW1) may be closed, the second switch 908 (SW2) may be opened and the third switch 920 may be opened.

Referring to FIG. 12, it may be determined if it may be determined if the battery of the cassette is fully charged. If the battery is fully charged, the first switch 904 (SW1) may be opened, the second switch 908 (SW2) may be closed and the third switch 920 may be opened. If the battery is not fully charged, it may be determined whether solar power is present or available. If solar power is present or available, the first switch 904 (SW1) may be closed, the second switch 908 (SW2) may be opened and the third switch 920 may be opened. If solar power is no present or available, the first switch 904 (SW1) may be opened, the second switch 908 (SW2) may be opened and the third switch 920 may be closed.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A solar device, comprising:
a housing including a first portion secured to a second portion, the first portion having a light-transmitting region;
a solar panel disposed beneath the light-transmitting region of the first portion of the housing;
an opening in a region of the second portion of the housing having first electrical contacts positioned therein, the first electrical contacts coupled to the solar panel;
a removable battery configured to be moved between an engaged position in which the removable battery is disposed in and releasably engaged with the opening, and a disengaged position in which the removable battery is released from the opening, the battery having second electrical contacts positioned to couple to the first electrical contacts when the removable battery is in the engaged position; and
at least one internal battery coupled to the solar panel and the first electrical contacts.

2. The solar device of claim 1, wherein the removable battery has a thickness substantially equal to a thickness of the opening such that an exposed surface of the removable battery is substantially planar with an exposed surface of the second portion of the housing when the removable battery is in the engaged position.

3. The solar device of claim 1, wherein the removable battery has a thickness greater than a thickness of the opening such that an exposed surface of the removable battery protrudes from an exposed surface of the second portion of the housing when the removable battery is in the engaged position.

4. The solar device of claim 1, wherein the first portion includes top and bottom flanges and the second portion includes side flanges, the top and bottom flanges configured to fit within recesses between the side flanges of the second portion, and the side flanges configured to fit within recesses between the top and bottom flanges.

5. The solar device of claim 3, wherein the opening is defined by a lower surface and three sidewalls in the second portion of the housing and a notch in the top flange of the first portion such that a surface of the removable battery is exposed through the top flange when the removable battery is in the engaged position.

6. The solar device of claim 4, further comprising a water-resistant grommet between the first flange of the first portion and a mouth of the opening in the surface of the second portion.

7. The solar device of claim 3, further comprising a rubber gasket disposed between edges of the first and second portions to prevent liquid and debris from entering the housing.

8. The solar device of claim 1, wherein the at least one internal battery is configured to store power generated by the solar panel and to transmit the stored power to the removable battery when the solar panel is not generating power.

9. The solar device of claim 1, further comprising a charging circuit including a booster circuit coupled to the solar panel.

10. The solar device of claim 1, wherein the opening includes a recess surrounded by a lip configured to receive a protrusion on a body of the removable battery.

11. The solar device of claim 1, wherein the removable battery includes projections on at least one sidewall, the projections corresponding to depressions in sidewalls of the opening such that the projections engage the depressions to guide the removable battery into the opening.

12. The solar device of claim 1, wherein the device includes at least one port configured to connect an electrical device.

13. The solar device of claim 1, wherein the at least one internal battery is configured to receive power from the at least one port.

14. The solar device of claim 1, wherein the device further comprises at least one light on a surface thereof, the at least one light coupled to the solar panel to receive power from the solar panel.

15. The solar device of claim 1, wherein the removable battery further includes an aperture configured to receive a protruding region of a spring-loaded plunger positioned within the opening to removably secure the removable battery within the housing in the engaged position.

16. The solar device of claim 14, further comprising a lever positioned on an external surface of the device, the lever configured to release the removable battery from the opening by moving the protruding region of the spring-loaded plunger away from the aperture when pressure is applied to the lever.

17. A solar device, comprising:
a housing including an opening on an external surface thereof, at least one electrical contact positioned within the opening;
a solar panel disposed in the housing and coupled to the at least one electrical contact; and
a cassette including at least one power-consuming device, the cassette having a shape substantially corresponding to a shape of the opening and including at least another electrical contact positioned to contact the at least one contact when the cassette is disposed in the opening to enable transfer of electrical energy generated by the solar panel to the cassette.

18. The solar device of claim 16, wherein the at least one power-consuming device includes at least one of a networking device, a power device, a lighting device, a data storage device, a data collection device, an environmental device and a navigation device.

19. The solar device of claim 16, further comprising internal batteries within the housing and coupled to the solar panel, the internal batteries capable of storing electrical energy generated by the solar panel and providing the stored electrical energy to the cassette.

20. The solar device of claim 16, wherein the solar panel includes a base formed from a polycrystalline material having a thickness of between about 0.5 mm and about 1 mm and is configured to provide about 1 amp of current to the cassette.

21. The solar device of claim 16, wherein the at least one power-consuming device includes a medical device.
